(19) United States
(12) Patent Application Publication
(10) Pub. No.: US 2026/0175987 A1
(43) Pub. Date: Jun. 25, 2026

(54) AIRCRAFT PROPULSION SYSTEM

(71) Applicant: Airbus Operations SAS, TOULOUSE (FR)

(72) Inventors: Mathieu MOREL, TOULOUSE (FR); Quentin GRANGE, TOULOUSE (FR)

(21) Appl. No.: 19/425,251

(22) Filed: Dec. 18, 2025

(30) Foreign Application Priority Data
Dec. 20, 2024 (FR) FR2414851

(51) Int. Cl. B64D 29/06; B64D 27/40; B64D 29/02

(52) U.S. Cl. CPC B64D 29/06; B64D 27/402; B64D 29/02

(57) ABSTRACT

A propulsion system for an aircraft having: a nacelle which has two cowls that are movable between a closed position and an open position, for each cowl, an actuation system arranged to move that cowl from the open position to the closed position and vice versa, and for each cowl, a holding system arranged to hold that cowl in the open position.

### CROSS-REFERENCES TO RELATED APPLICATIONS

This application claims the benefit of French Patent Application Number FR2414851 filed on Dec. 20, 2024, the entire disclosure of which is incorporated herein by way of reference.

### FIELD OF THE INVENTION

The present invention relates to an aircraft propulsion system comprising a nacelle. In particular, the nacelle has two movable cowls, an actuation system for each cowl and a system for holding the cowls in the open position, which is separate from the actuation system. The invention also relates to an aircraft comprising such a propulsion system.

### BACKGROUND OF THE INVENTION

FIG. 1 shows a propulsion system 500 of the prior art. This propulsion system 500 is fitted in an aircraft and conventionally comprises an engine, such as a jet engine, taking the form of a core 502 and surrounded by a nacelle 504 which forms, among other things, an aerodynamic surface around the core 502, and the propulsion system 500 is generally fixed underneath a wing of the aircraft via a mounting pylon 503.

The nacelle 504 has cowls 506 which are hingedly mounted on the mounting pylon 503 by means of hinges 508 and are locked in the closed position (like the port-side cowling 506 illustrated in FIG. 1) by a locking system which locks the cowls 506 to one another at a lower spar 510 integrated in each cowl 506.

For maintenance reasons, it is necessary to be able to open the cowls 506 (like the starboard-side cowl 506 illustrated in FIG. 1) by pivoting them about hinge pins 508. To open a cowl 506, the technician unlocks the locking system and lifts the cowl 506, the reverse maneuver making it possible to close the cowl 506.

A jack 512 is present to assist with the opening of the cowl 506 and to hold the cowl 506 in the open position. In particular, the jack 512 is mounted between the cowl 506 and a structure of the core 502.

With such an arrangement, the cowls rest on the core and, during certain maintenance operations, in particular when the core is being taken out, the cowls cannot be held in the open position without the use of tools or equipment external to the aircraft. It is therefore desirable to find an arrangement that provides improvements.

An aim of the present invention is to provide an aircraft propulsion system which makes maintenance operations easier.

### SUMMARY OF THE INVENTION

Proposed for this purpose is an aircraft propulsion system comprising:
a nacelle which has two cowls each hingedly mounted about a hinge pin and movable between a closed position and an open position,
for each cowl, an actuation system having a first end hingedly mounted on said cowl and a second end arranged to be hingedly mounted removably on a casing of an engine, wherein said actuation system is arranged to move said cowl from the open position to the closed position and vice versa, and
for each cowl, a holding system separate from said actuation system and arranged to hold said cowl in the open position.

With such an arrangement, each cowl can be easily opened by the actuation system and held in the open position by the holding system, even when the core is absent.

Advantageously, each second end has a quick-release system.

Advantageously, each cowl has a first attachment means to which the second end of the actuation system associated with said cowl is removably fastened.

According to a particular embodiment, each holding system has a telescopic holding rod with a third end and a fourth end, wherein said third end is hingedly mounted on said associated cowl, wherein said fourth end is intended to be hingedly mounted on a mounting pylon, and wherein said holding rod is movable between a first position in which it has a first length corresponding to the open position and a second position in which it has a second length corresponding to the closed position.

Advantageously, each holding rod has immobilizing means arranged to alternately take a locking position in which the holding rod is immobilized in its first position and an unlocking position in which the holding rod can move from its first position to its second position and vice versa.

Advantageously, each cowl has a second attachment means to which the fourth end of the holding rod associated with said cowl is removably fastened.

According to a particular embodiment, the two holding systems take the form of a bar having a fifth end and a sixth end, wherein said fifth end is removably fastened to one of the two cowls and wherein said sixth end is removably fastened to the other of the two cowls.

Advantageously, the fifth end and the sixth end have a quick-release system.

Advantageously, a cowl bears two attachment means to which the fifth end and the sixth end are removably fastened.

The invention also provides an aircraft comprising a mounting pylon and a propulsion system according to one of the preceding variants, fastened to said mounting pylon.

### BRIEF DESCRIPTION OF THE DRAWINGS

The abovementioned features of the invention, along with others, will become more clearly apparent upon reading the following description of several exemplary embodiments, said description being given with reference to the appended drawings, in which:

FIG. 1 is a schematic representation, in a rear view, of a propulsion system of the prior art,

FIG. 2 is a side view of an aircraft comprising a propulsion system according to the invention,

FIG. 3 is a schematic representation, in a rear view, of a propulsion system according to a first embodiment of the invention, with one of the cowls in the closed position and the other cowl in the open position, and

FIG. 4 is a schematic representation, in a rear view, of a propulsion system according to a second embodiment of the invention, with each of the cowls in the open position.

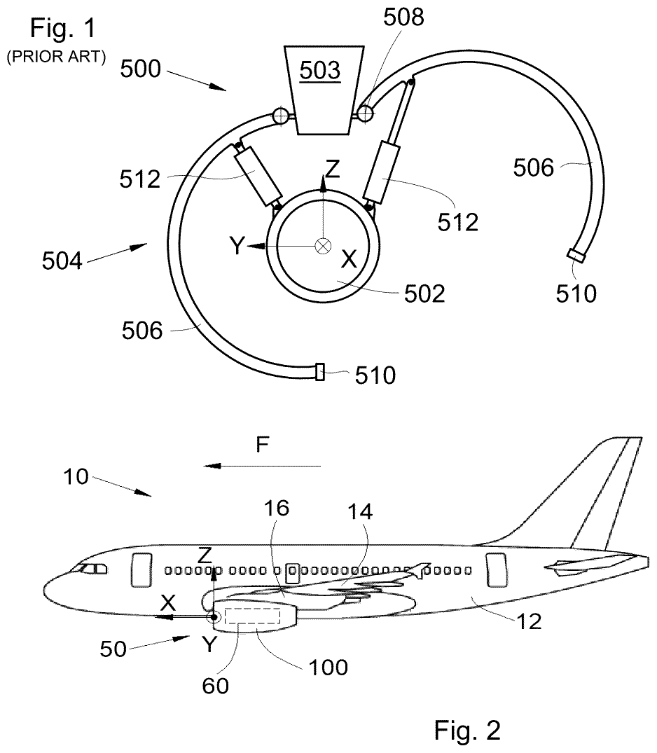

### DETAILED DESCRIPTION OF THE PREFERRED EMBODIMENTS

In the following description, terms relating to a position are considered in relation to an aircraft in a position of forward movement as depicted in FIG. 2, in which the arrow F shows the direction of forward movement of the aircraft in flight.

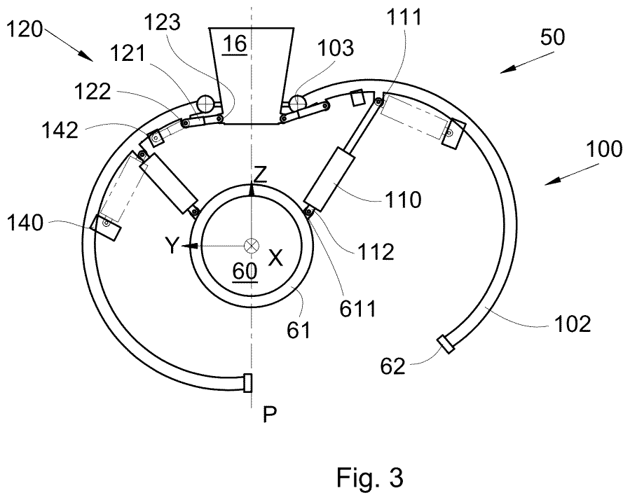

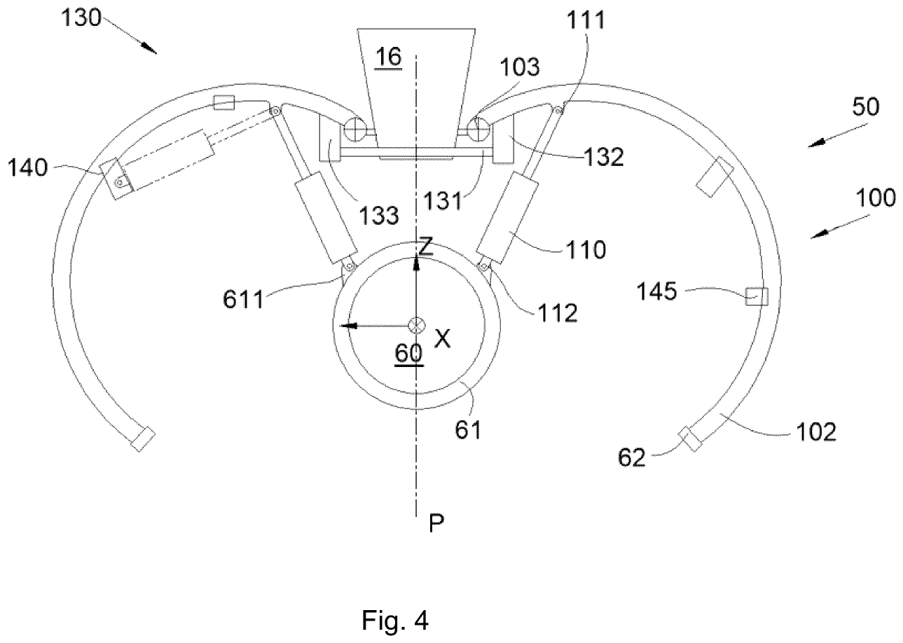

FIG. 2 shows an aircraft 10 that has a fuselage 12 on either side of which a wing 14 is fastened. Each wing 14 supports at least one propulsion system 50 by means of a mounting pylon 16 fastened between a structure of the wing 14 and a structure of the propulsion system 50. FIG. 3 and FIG. 4 show propulsion systems 50 according to two embodiments of the invention.

The propulsion system 50 according to the invention comprises an engine 60 (shown in dashed lines in FIG. 2) surrounded by a nacelle 100.

In the following description, and by convention, X denotes the longitudinal axis of the nacelle 100, which is parallel to the longitudinal axis of the aircraft 10, or roll axis, oriented positively in the direction of forward movement of the aircraft 10; Y denotes the transverse axis, which is parallel to the pitch axis of the aircraft 10 which is horizontal when the aircraft 10 is on the ground; and Z denotes the vertical axis, which is parallel to the yaw axis when the aircraft 10 is on the ground, the three directions associated with these axes X, Y and Z being mutually orthogonal.

The nacelle 100 has a vertical midplane P of symmetry which coincides with the vertical plane XZ and, in the embodiments of the invention presented below, the nacelle 100 has a cowl 102 on either side of the vertical midplane P.

Each cowl 102 in this case takes the form of a half-cylinder such that together they form a cylinder surrounding the engine 60.

The engine 60 takes the form for example of a turbofan engine with a core 61 accommodated inside the nacelle 100. The cowl 102 may form, for example, a cowl for a fan of the engine 60 or a cowl for a thrust reversal system.

Each cowl 102 is hingedly mounted about a hinge pin 103 and can be mounted on a structure, which can be a structure of the mounting pylon 16 (as illustrated) or a structure of the propulsion system 50. The hinge pin 103 is parallel to the longitudinal axis X and each cowl 102 is movable between a closed position in which the cowl 102 is closed up around the engine 60 and an open position in which the cowl 102 has been moved away from the engine 60.

In FIG. 3, the port-side cowl 102 is in the closed position and the starboard-side cowl 102 is in the open position. In FIG. 4, the two cowls 102 are in the open position.

In the closed position, the two cowls 102 engage with one another, at a lower spar 62 of each cowl 102. The lower spar 62 of one of the cowls 102 thus comes into contact with the lower spar 62 of the other cowl 102. In the closed position, the spars 62 are arranged at the bottom portion of the nacelle 100, at 6 o'clock.

Each hinge pin 103 is disposed at the top of the associated cowl 102.

Conventionally, in order to lock each cowl 102 in the closed position, the nacelle 100 has locking systems (not illustrated) which can be accessed from outside the nacelle 100 by a technician. Each locking system can take any form known to a person skilled in the art and it alternatively takes a locked position in which it locks the cowls 102 in the closed position, or an unlocked position in which it does not lock the cowls 102 which are then free to move from the closed position to the open position and vice versa.

The nacelle 100 thus has two cowls 102 and, for each cowl, an actuation system 110 which causes said cowl 102 to move from the open position to the closed position and vice versa. Each actuation system 110 has a first end 111 hingedly mounted on the associated cowl 102 and a second end 112 hingedly mounted removably on a casing 611 of the engine 60 and more particularly in this case of the core 61.

More specifically, the first end 111 is hingedly mounted on the cowl 102 by means of a pivot or ball-joint connection and, in the same way, the second end 112 is hingedly mounted on the casing 611 by means of a pivot or ball-joint connection. In particular, the pivot connections have an axis which is parallel overall to the longitudinal axis X.

The second end 112 is “removably” fastened to the casing 611 in the sense that they can be disconnected without destroying either the casing 611 or the actuation system 110. The same definition applies for the removable fastenings described below.

The actuation system 110 is for example an electromechanical or electrohydraulic linear actuator or any suitable type of jack.

In the embodiments presented here, each actuation system 110 is arranged to alternately extend, to make the associated cowl 102 move from the closed position to the open position, and retract, to make the associated cowl 102 move from the open position to the closed position.

In addition, the propulsion system 50 comprises, for each cowl 102, a holding system 120, 130 which is separate from the actuation system 110 associated with said cowl 102. The holding system 120, 130 is arranged to hold the associated cowl 102 in the open position.

Such an arrangement thus makes it possible to separate the function of moving and the function of holding the cowls 102 and it is then possible to take out the core 61 while still holding the cowls 102 in the open position.

In order to make it easier to disconnect each second end 112 from the casing 611, said second end 112 has a quick-release system. “Quick-release” is understood to mean the use of a fastening mechanism which can be detached, preferably without tools, in a single action by an operator. Such a quick-release system is for example a system of the ball-lock pin type (also known as a self-locking stop pin) or a system of the J-lock type (i.e. a mechanism with a J-shaped movable part that engages on a fixed part so as to trap, between the J-shaped movable part and the fixed part, an attachment pin for example located on the engine casing or the cowl). Such a quick-release system allows operators to disconnect the second end 112 quickly and preferably without a specific tool, in order to optimize the duration of maintenance operations.

In order to prevent the second end 112 from swinging when it is detached, each cowl 102 has a first attachment means 140 to which the second end 112 of the actuation system 110 associated with said cowl 102 is removably fastened. The actuation systems 110 in chain line represent the actuation systems 110 when the second end 112 is detached from the casing 611 and attached to the associated first attachment means 140.

FIG. 3 shows a holding system 120 according to a first type and FIG. 4 shows a holding system 130 according to a second type. Each of these holding systems 120 and 130 holds the cowls 102 in the open position even in the absence of the core 61, since these holding systems 120 and 130 bear either against the mounting pylon 16 or against the other cowl 102 and not against the core 61.

In the first embodiment of the invention shown in FIG. 3, each holding system 120 has a holding rod 121. The holding rod 121 has a third end 122 hingedly mounted on the associated cowl 102 and a fourth end 123 hingedly mounted on the mounting pylon 16.

The third end 122 and the fourth end 123 are respectively hingedly mounted by pivot or ball-joint connections about an axis which is parallel overall to the longitudinal axis X. To do this, the cowl 102 and the mounting pylon 16 conventionally have attachment means which can take any form known to a person skilled in the art, such as clevis connections, and are therefore not described in detail here.

The holding rod 121 is telescopic and is thus movable between a first position in which it has a first length (in this case the greatest length) corresponding to the open position and a second position in which it has a second length (in this case the shortest length) corresponding to the closed position.

The holding rod 121 can have immobilizing means arranged to alternately take a locking position in which the holding rod 121 is immobilized in its first position and an unlocking position in which the holding rod 121 can move from its first position to its second position and vice versa.

The holding rod 121 is thus, for example, a self-locking type, i.e., it locks automatically in its first position to secure the open position of the cowl 102. The holding system 120 includes for example an unlocking handle (not shown in the figures) which makes it possible to release the immobilizing means. The unlocking handle can be remote so that a technician can access it more easily.

During operation, the actuation system 110 opens up the cowl 102, thereby causing deployment of the holding rod 121 which is immobilized under the effect of the immobilizing means in the open position of the cowl 102. The actuating system 110 then plays no role in holding the cowl 102 and, if necessary, its second end 112 can be separated from the casing 611 of the engine 60, allowing the core 61 to be subsequently taken out.

According to a particular embodiment, the third end 122 and the fourth end 123 remain fastened to the cowl 102 and to the mounting pylon 16, respectively, whether the cowl 102 is in the closed position or in the open position.

According to another particular embodiment, the fourth end 123 of the holding rod 121 is removably fastened to the mounting pylon 16 and each cowl 102 has a second attachment means 142 to which the fourth end 123 of the holding rod 121 associated with said cowl 102 is removably fastened. Such an arrangement makes it possible to separate the holding rod 121 from the mounting pylon 16, in particular in the closed position of the cowl 102. The holding rod 121 in chain line represents the holding rod 121 when the fourth end 123 is detached from the mounting pylon 16 and attached to the second attachment means 142.

In order to make it easier to disconnect each fourth end 123 from the mounting pylon 16, said fourth end 123 has a quick-release system, as described above.

In the second embodiment of the invention shown in FIG. 4, the two holding systems 130, i.e., those of the two cowls 102, take the form of a single bar 131 which is thus shared by the two holding systems 130. The bar 131 has a fifth end 132 removably fastened to one of the two cowls 102 and a sixth end 133 removably fastened to the other of the two cowls 102.

Preferably, the fifth end 132 and the sixth end 133 each have a quick-release system as described above.

When the cowls 102 are in the closed position, the bar 131 is removed and fastened inside the aircraft 10 and preferably inside the nacelle 100, by two attachment means 145 provided for this purpose on a cowl 102, the fifth end 132 and the sixth end 133 each being removably fastened to one of the attachment means 145. Owing to the length of the bar 131, it is preferably fastened parallel to the longitudinal axis X between the attachment means 145.

During operation, the actuation system 110 opens the cowl 102, and when the open position is reached, the bar 131 is fitted between the two cowls 102. The actuating system 110 then plays no role in holding the cowl 102 and, if necessary, its second end 112 can be separated from the casing 611 of the engine 60, allowing the core 61 to be subsequently taken out.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A propulsion system for an aircraft, the propulsion system comprising:
a nacelle which has two cowls each hingedly mounted about a hinge pin and movable between a closed position and an open position;
for each cowl of the two cowls, an actuation system having a first end hingedly mounted on a cowl and a second end arranged to be hingedly mounted removably on a casing of an engine, wherein said actuation system is arranged to move the cowl from the open position to the closed position and from the closed position to the open position; and
for each cowl of the two cowls, a holding system separate from the actuation system and arranged to hold the cowl in the open position,
wherein each holding system has a telescopic holding rod with a third end and a fourth end,
wherein the third end is hingedly mounted on a cowl,
wherein the fourth end is configured to be hingedly mounted on a mounting pylon, and
wherein the holding rod is movable between a first position in which the holding rod has a first length corresponding to the open position and a second position in which the holding rod has a second length corresponding to the closed position.

2. The propulsion system according to claim 1, wherein the second end of the actuation system comprises a quick-release system.

3. The propulsion system according to claim 1, wherein each cowl of the two cowls has a first attachment means to which the second end of the actuation system is removably fastened.

4. The propulsion system according to claim 1, wherein the holding rod comprises immobilizing means arranged to alternately take a locking position in which the holding rod is immobilized in the first position and an unlocking position in which the holding rod is configured to move from the first position to the second position and from the second position to the first position.

5. The propulsion system according to claim 1, wherein each cowl of the two cowls comprises a second attachment means to which the fourth end of the holding rod is removably fastened.

6. An aircraft comprising:
a mounting pylon; and
the propulsion system according to claim 1 fastened to said mounting pylon.
